(19) United States
(12) Patent Application Publication
(10) Pub. No.: US 2006/0178129 A1
(43) Pub. Date: Aug. 10, 2006

(54) Apparatus and method for selective call acceptance in a wireless network

(75) Inventor: Anuradha K. Appaji, Plano, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 11/055,378

(22) Filed: Feb. 10, 2005

(51) Int. Cl. H04B 1/00; H04B 7/00; H04M 11/00

(52) U.S. Cl. 455/405

(57) ABSTRACT

A system for providing automatic Selective Call Acceptance (SCA) service to a plurality of mobile stations capable of communicating with a wireless network is provided. The system includes a subscriber records database and an SCA controller. The subscriber records database is capable of storing a plurality of subscriber records. Each subscriber record is associated with one of the mobile stations and includes SCA data for providing automatic SCA service to the associated mobile station. The SCA data includes an SCA triggers list, which includes user-defined trigger events. The SCA controller is capable of accessing the subscriber records database and to provide automatic SCA service to at least one of the mobile stations based on the SCA data stored in the subscriber record for the associated mobile station.

### TECHNICAL FIELD OF THE INVENTION

The present invention relates generally to wireless networks and, more specifically, to a mechanism for automatically triggering selective call acceptance for a mobile station.

### BACKGROUND OF THE INVENTION

Wireless communications systems, including cellular phones, paging devices, personal communication services (PCS) systems, and wireless data networks, have become ubiquitous in society. To attract new customers, wireless service providers continually seek to improve wireless services cheaper and better, such as by implementing new technologies that reduce infrastructure costs and operating costs, increase handset battery lifetime, and improve quality of service (e.g., signal reception).

One wireless service feature that is popular with many subscribers is Selective Call Acceptance (SCA). Selective Call Acceptance enables a user of a mobile station to specify a list of phone numbers that are to be automatically rejected (e.g., forwarded to voice mail) whenever the mobile station user activates the SCA feature. However, all other phone numbers that are not on the specified list of phone numbers will still be connected to the mobile station.

Selective Call Acceptance (SCA) is currently supported by a number of wireless standards, including the CDMA standards (i.e., IS-2000, 1×EV-DV, etc.). When a user activates SCA, incoming calls from the predetermined phone number list are automatically forwarded to a designated number or a voice message system. The user is able to activate SCA on the basis of a pre-agreement with the service provider.

The following is a description of the operation of the SCA feature (or service) under the CDMA IS-654A standard. Other standards operate in a similar manner. Initially, the mobile station user activates SCA using the graphical user interface (GUI) of the mobile station (e.g., cell phone, wireless laptop, wireless PDA, and the like) and enters (or registers) the call diversion number(s) (i.e., the phone number of the voice mail system or other phone/device to which calls are to be forwarded). Next, the user enters the phone numbers (or Caller IDs) of the diverted phones or other devices that are to be forwarded to the voice mail system or other device. The user is also able to register the last calling number into the selective list. When the SCA service is not required, the user is able to de-register and deactivate the SCA service via the GUI of the mobile station. Additionally, the user is able to remove a number from the SCA list.

However, the prior art SCA feature has a number of drawbacks. User intervention is required to activate the SCA feature. There is no method for automatically activating the SCA feature. The SCA feature is dependent on the memory of the user. Thus, the user must remember to activate the SCA feature prior to, for example, entering a meeting, returning home, when the battery is low, and the like. Other than the benefit of rejecting calls, there is no method to extend the SCA feature to optimize the resource usage of the mobile station device.

Therefore, there is a need in the art for an improved Selective Call Acceptance (SCA) service for use in wireless networks. In particular, there is a need for a wireless network that provides an SCA feature that is not dependent on user memory and user intervention.

### SUMMARY OF THE INVENTION

The proposed invention provides a mechanism by which a mobile station is capable of activating the Selective Call Acceptance (SCA) service without user intervention under certain pre-determined conditions. The present invention modifies conventional SCA service by adding conditions under which the SCA feature is automatically initiated by the mobile station and/or a network control device on behalf of the user.

To address the above-discussed deficiencies of the prior art, it is a primary object of the present invention to provide, for use in a wireless network comprising a plurality of base station capable of communicating with a plurality of mobile stations, a system for providing automatic Selective Call Acceptance (SCA) service to the plurality of mobile stations. According to an advantageous embodiment of the present invention, the system comprises: 1) a subscriber records database and 2) an SCA controller. The subscriber records database stores a plurality of subscriber records. Each subscriber record is associated with one of the mobile stations and includes SCA data for providing automatic SCA service to the associated mobile station. The SCA data includes an SCA triggers list, which includes user-defined trigger events. The SCA controller accesses the subscriber records database and provides automatic SCA service to at least one of the mobile stations based on the SCA data stored in the subscriber record for the associated mobile station.

According to one embodiment of the present invention, the trigger events comprise at least one of a low battery condition, a roaming condition, and a peak calling hours condition.

According to another embodiment of the present invention, the SCA controller is further capable of monitoring call session state information for the mobile stations to determine if an SCA trigger event stored in the subscriber record associated with one of the mobile stations is matched.

According to a further embodiment of the present invention, the SCA controller is further capable of automatically activating SCA service for one of the mobile stations when the SCA controller determines that one of the SCA trigger events stored in the subscriber record associated with the mobile station is matched.

According to a still further embodiment of the present invention, the SCA controller further is capable of monitoring the call session state information for the mobile station receiving automatic SCA service to determine if the SCA trigger event is still matched and to determine if one of the remaining SCA trigger events for the mobile station is matched.

According to a yet further embodiment of the present invention, the SCA controller is further capable of automatically deactivating SCA service when the SCA controller determines that the SCA trigger event is unmatched and the remaining SCA trigger events for the mobile station are unmatched.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; “each” means every one of at least a subset of the identified items; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network in which automatic and conditional selective call acceptance (SCA) is implemented according to the principles of the present invention;

FIG. 2A illustrates an exemplary mobile switching center (MSC) in greater detail according to an exemplary embodiment of the present invention;

FIG. 2B illustrates the subscriber records database (DB) in greater detail according to an exemplary embodiment of the present invention;

FIG. 3 illustrates an exemplary wireless mobile station according to an advantageous embodiment of the present invention;

FIG. 4 is a flow diagram illustrating automatic and conditional selective call acceptance (SCA) according to an exemplary embodiment of the present invention; and

FIG. 5 illustrates an exemplary wireless mobile station according to an alternate embodiment of the present invention

### DETAILED DESCRIPTION OF THE INVENTION

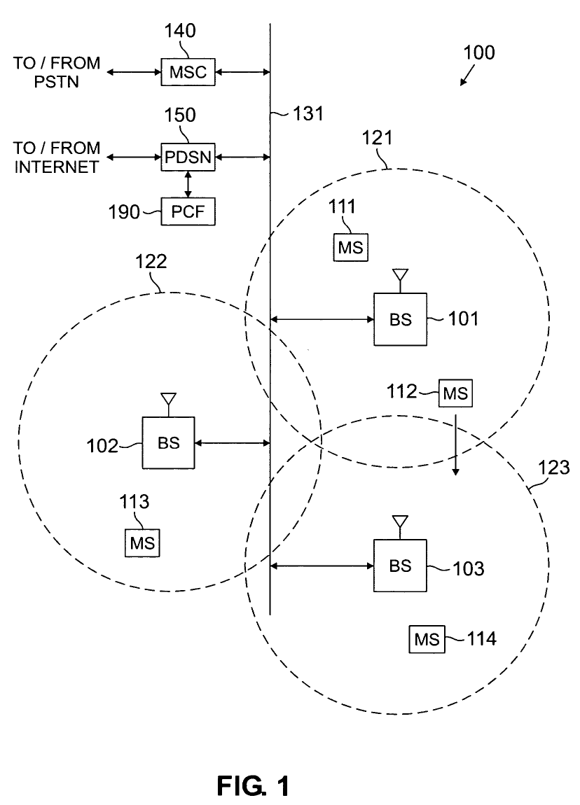

FIGS. 1 through 5, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, in which automatic and conditional selective call acceptance (SCA) is implemented according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to, for example, the IS-2000 standard (i.e., CDMA2000). In an advantageous embodiment of the present invention, mobile stations 111-114 are capable of receiving data traffic and/or voice traffic on two or more CDMA channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

BS 101, BS 102 and BS 103 provide SCA service for mobile stations 111-114 based on receiving SCA activation and deactivation messages from mobile stations 111-114. After establishing SCA service, as described in more detail below, a user of mobile station 111, for example, may send an SCA activation message from mobile station 111 to the corresponding BS 101. The SCA activation message prompts BS 101 to activate SCA service for mobile station 111. Later, the user may send an SCA deactivation message from mobile station 111 to BS 101 in order to deactivate SCA service for mobile station 111. For some embodiments, the SCA activation and deactivation messages may each comprise predefined keystrokes on mobile station 111. However, it will be understood that the messages may comprise any suitable format without departing from the scope of the present invention.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

According to the principles of the present invention, a mechanism is provided by which mobile stations 111-114 may activate the Selective Call Acceptance (SCA) service without user intervention under certain pre-determined conditions. This is achieved by an SCA controller that is implemented in the wireless network and by a corresponding SCA control application program that is implemented in the mobile station. The SCA controller in the wireless network may be implemented at a number of points in the wireless infrastructure, including in or at MSC 140 and/or base stations 101-103, as well as in the mobile station. This is particularly important in this embodiment which does not rely on air-interface messages to convey battery power level information. In the advantageous embodiment described below, the SCA controller will be associated with MSC 140, due to the central location of MSC 140. However, this is by way of illustration only and should not be construed so as to limit the scope of the present invention.

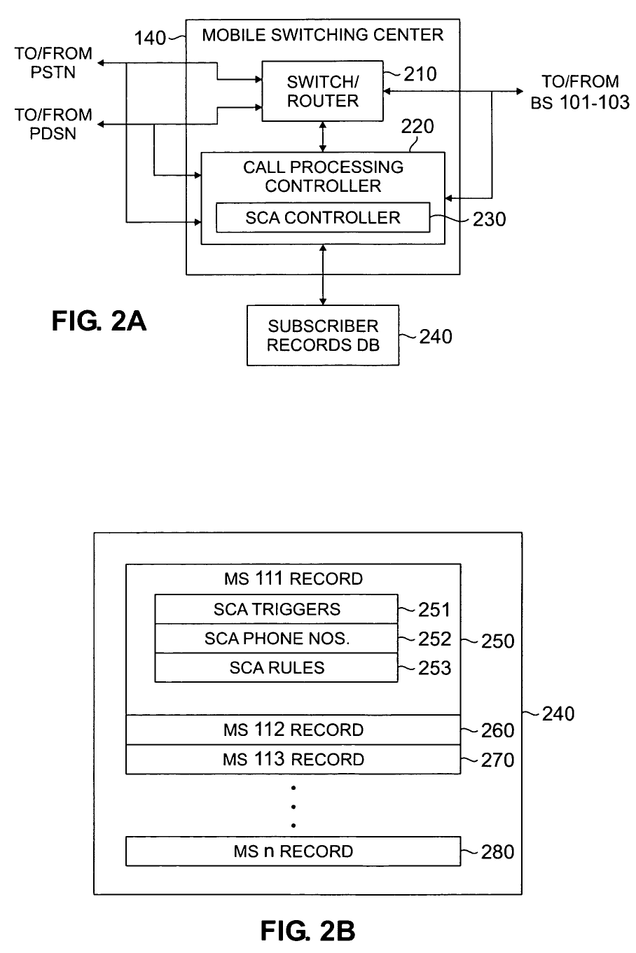

FIG. 2A illustrates exemplary mobile switching center (MSC) 140 in greater detail according to an exemplary embodiment of the present invention. MSC 140 comprises switching/routing circuitry 210 and call processing controller 220. In an exemplary embodiment of the present invention, Selective Call Acceptance (SCA) controller 230 may be implemented as part of call processing controller 220. Alternatively, Selective Call Acceptance (SCA) controller 230 may be implemented as a separate device associated with call processing controller 220. Subscriber records database 240 is associated with MSC 140.

FIG. 2B illustrates subscriber records database (DB) 240 in greater detail according to an exemplary embodiment of the present invention. Subscriber records database 240 stores N subscriber records, including exemplary subscriber records 250, 260, 270 and 280. Exemplary subscriber record 250 is associated with MS 111, exemplary subscriber record 260 is associated with MS 112, and exemplary subscriber record 270 is associated with MS 113.

Exemplary subscriber record 250 comprises SCA triggers list 251, SCA phone numbers list 252, and SCA rules list 253. SCA triggers list 251 comprises a list of user-defined trigger events (e.g., low battery, roaming, peak hours) that cause the automatic activation and/or deactivation of the SCA feature. SCA phone numbers list 252 contains both the call diversion number(s) to which calls are to be forwarded and the diverted phone numbers (caller Ids) of the devices that are to be forwarded to the call diversion numbers. SCA rules list 253 comprises an optional set of user-defined rules that further refine the use of the trigger events in SCA triggers list 251. For example a rule may cause the SCA feature to be activated if both 1) the battery is low and 2) the mobile station is roaming, but not if only one of these conditions is true. Subscriber records 260, 270 and 280 are substantially identical to subscriber record 250 and need not be explained separately.

Switching/routing circuitry 210 comprises conventional switches and/or routers that transfer data traffic between base stations 101-103 and the trunk lines (or circuits) of the PSTN and PDSN 150. In addition to data traffic (i.e., voice signal, packet data), MSC 140 receives control signals from base stations 101-103 and from the PSTN or Internet. These control signals are used to set up and break down call connections, to initiate conference calls, to forward calls, and to activate and deactivate Selective Call Acceptance (SCA).

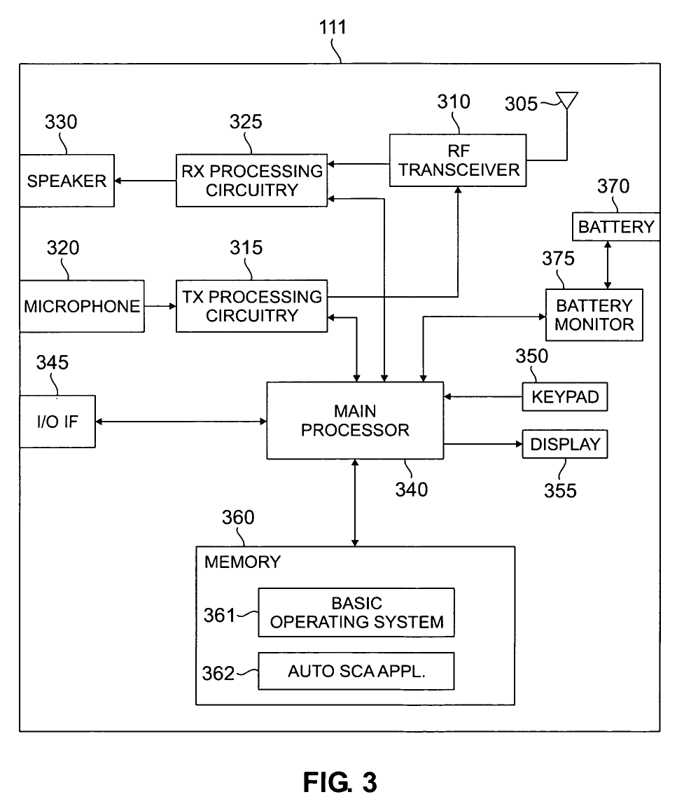

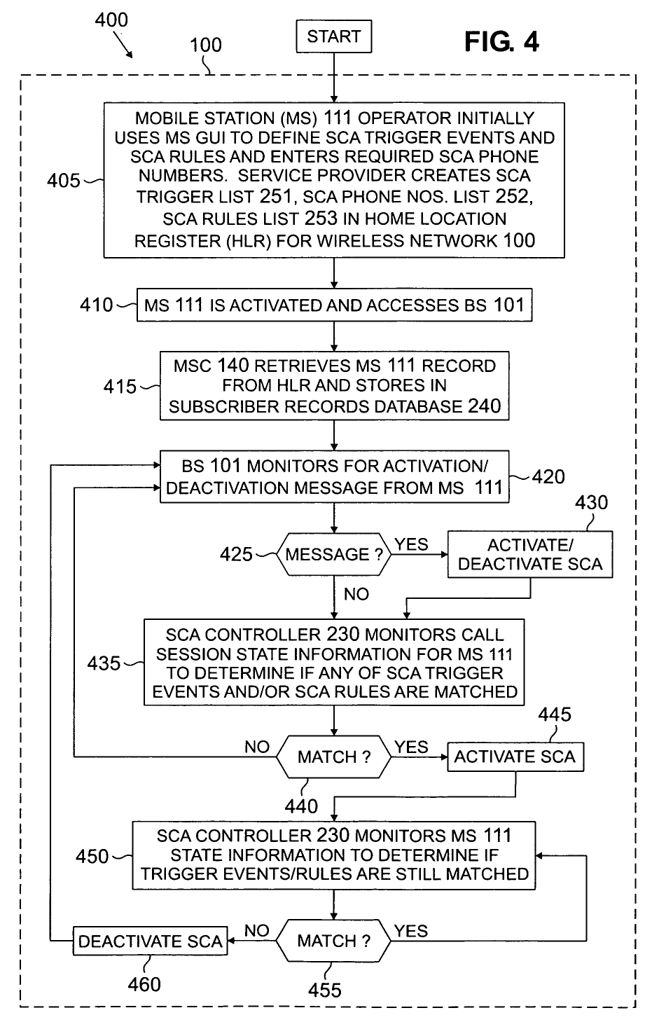

In MSC 140, these control signals are sent to call processing controller 220, which comprises a plurality of call processors that handle call control functions. At least some of these call processors comprise SCA controller 230 and are responsible for carrying out automatic Selective Call Acceptance according to the principles of the present invention. SCA controller 230 may access data, such as lists 251, 252 and 253, stored in subscriber records database 240 in order to provide automatic Selective Call Acceptance for mobile stations having associated subscriber records stored in subscriber records database 240. Additional details describing the operation of SCA controller 230 and the use of SCA triggers list 251, SCA phone numbers list 252, and SCA rules list 253 are provided below with respect to FIGS. 3 and 4.

FIG. 3 illustrates wireless mobile station 111 according to an advantageous embodiment of the present invention. Wireless mobile station 111 comprises antenna 305, radio frequency (RF) transceiver 310, transmit (TX) processing circuitry 315, microphone 320, and receive (RX) processing circuitry 325. MS 111 also comprises speaker 330, main processor 340, input/output (I/O) interface (IF) 345, keypad 350, display 355, memory 360, battery 370, and battery monitor 375. Memory 360 further comprises basic operating system (OS) program 361 and automatic Selective Call Acceptance (SCA) application program 362.

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 111. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 111 with the ability to connect to other devices such as laptop computers and handheld computers. I/O interface 345 is the communication path between these accessories and main controller 340.

Main processor 340 is also coupled to keypad 350 and display unit 355. The operator of mobile station 111 uses keypad 350 to enter data into mobile station 111. Display 355 may be a liquid crystal display capable of rendering text and/or at least limited graphics from web sites. Alternate embodiments may use other types of displays.

Main processor 340 is also coupled to battery monitor 375, which is coupled to battery 370. Battery 370 provides power that allows mobile station 111 to operate. Battery 370 may be charged by being plugged into an electrical outlet or by any other suitable means. Battery 370 is then discharged to varying degrees by powering mobile station 111.

Battery monitor 375 monitors the level of power remaining in battery 370 and provides battery power level information to main processor 340 display on display 355. For example, battery monitor 375 may monitor the power level of battery 370 in relation to four predefined power levels, namely 100%, 75%, 50% and 25%. For this example, battery monitor 375 may prompt main processor 340 to provide an icon on display 355 indicating battery 370 is charged 100% when the power level is between approximately 75% and 100%, 75% when the power level is between approximately 50% and 75%, 50% when the power level is between approximately 25% and 50%, and 25% when the power level is between approximately 0% and 25%. It will be understood that battery monitor 375 may monitor the power level of battery 370 in relation to any suitable number of predefined power levels and may provide the corresponding information to the user in any suitable manner without departing from the scope of the present invention.

Main processor 340 is responsible for executing automatic Selective Call Acceptance (SCA) application program 362 in accordance with the principles of the present invention. In one such operation, automatic SCA application program 362 receives user input through keypad 350 and display 355 and sends that input to wireless network 100 for storing in a subscriber record in the Home Location Register (not shown).

This input may comprise user-defined trigger events, call diversion number(s) to which calls are to be forwarded and diverted phone numbers of the devices that are to be forwarded to the call diversion numbers, user-defined rules that further refine the use of the trigger events and/or any other suitable information for providing SCA service to the user. It will be understood that the input may comprise initial information for establishing SCA service for the user, as well as additional, edited, and deleted information for updating the SCA service for the user. As described in more detail below in connection with FIG. 4, the information stored in the Home Location Register may be retrieved for storage in SCA triggers list 251, SCA phone numbers list 252, and SCA rules list 253 while mobile station 111 is in communication with base station 101.

Upon receiving a selection of the low battery option as a triggering event, automatic SCA application program 362 may prompt the user to enter a battery power level at which the user wants mobile station 111 to automatically activate SCA service. For another embodiment, SCA service may be activated based on a predetermined battery power level.

Upon receiving a selection of the peak calling hours option as a triggering event, automatic SCA application program 362 may prompt the user to enter the peak calling hours during which SCA will be automatically activated by mobile station 111. For another embodiment, SCA controller 230 provides the peak calling hours based on information from the service provider for the user of mobile station 111.

In another operation, automatic SCA application program 362 receives the power level information for battery 370 that is provided to main processor 340 from battery monitor 375. In an exemplary embodiment of the present invention, automatic SCA application program 362 determines whether or not the power level of battery 370 is defined as a trigger event and, if so, whether or not the power level is low enough to trigger SCA activation. In such an embodiment, automatic SCA application program 362 sends an SCA activation message to BS 101 when the user has selected a low-battery trigger event and the power level has fallen below the user-defined level for that trigger event. Thus, for this embodiment, BS 101 would receive a message equivalent to the message that would be received from a user of mobile station 111 who was manually activating SCA service. When battery 370 is replaced or charged to the appropriate level, automatic SCA application program 362 sends to BS 101 an SCA deactivation message, which is equivalent to the message that would be received from a user of mobile station 111 who was manually deactivating SCA service.

FIG. 4 depicts flow diagram 400, which illustrates automatic and conditional selective call acceptance (SCA) in wireless network 100 according to the principles of the present invention. Initially, the operator (user) of mobile station (MS) 111 uses the graphical user interface (GUI) to perform a menu-driven procedure that enables the operator to define SCA trigger events and SCA rules. The operator also uses the GUI of MS 111 to enter the required SCA phone numbers, namely the calling phone numbers that are to be forwarded and the phone number(s) of the voice mail system or other voice to which the calling phone numbers are to be forwarded (or diverted). The wireless service provider uses the data entered by the operator to create SCA triggers list 251, SCA phone numbers list 252, and SCA rules list 253. These SCA lists are store in the Home Location Register (not shown) for wireless network 100 (process step 405).

After the SCA set-up procedure described above has been completed, at some later point, MS 111 is activated and accesses wireless network 100 via BS 101 (process step 410). MSC 140 retrieves the subscriber record that is associated with MS 111 from the Home Location Register and stores that subscriber record (e.g., as subscriber record 250) in subscriber records database 240 (process step 415). In an exemplary embodiment of the present invention, BS 101 monitors for an SCA activation or deactivation message from MS 111 (process step 420).

If SCA service has not been activated and BS 101 receives an SCA activation message from MS 111 or if SCA service has been activated and BS 101 receives an SCA deactivation message from MS 111 (process step 425), BS 101 activates or deactivates SCA service based on the message (process step 430). However, if no such message has been received (process step 425) or after BS 101 has activated or deactivated SCA service (process step 430), SCA controller 230 monitors call session state information for MS 111 to determine if any of SCA trigger events and/or SCA rules stored in subscriber record 250 are matched (process step 435). If SCA controller 230 does not find a match (process step 440), BS 101 may continue to monitor for an SCA activation or deactivation message from MS 111 (process step 420). However, if SCA controller 230 finds a match (process step 440), SCA controller 230 activates SCA service if not already activated by BS 101 (process step 445).

SCA controller 230 monitors MS 111 state information to determine if any of SCA trigger events and/or SCA rules stored in subscriber record 250 are still matched (process step 450). If SCA controller 230 continues to find a match (process step 455), SCA controller 230 continues to monitor MS 111 state information (process step 450). However, if SCA controller 230 does not still find a match (process step 455), SCA controller 230 deactivates SCA service (process step 460), after which BS 101 may continue to monitor for an SCA activation or deactivation message from MS 111 (process step 420).

In this way, automatic SCA activation is provided based on user-defined conditions, such as low battery, roaming, and peak calling hours. This prevents the user from having to activate SCA service manually or to monitor the battery power in order to conserve power for the most important calls. By using the option of rejecting low priority calls when battery power is low, the user may reserve battery resources for high priority calls, which is especially beneficial for business travelers and emergency workers. In addition, using some aspects of the present invention, mobile station 111 may receive only the most important calls during peak calling hours, which are the hours during which providers typically charge a higher calling rate per minute, and while mobile station 111 is roaming, which also costs a premium. Thus, the user is able to manage incoming calls in an economic fashion because he/she is able to prevent unnecessary charges during peak hours and while roaming that would be incurred by receiving low priority calls.

It was noted above that SCA controller in the wireless network may be implemented entirely in mobile station 111. In such an alternate embodiment, no changes are required to the network infrastructure and mobile station 111 may determine entirely by itself if any trigger events (e.g., roaming, peak hours, etc.) have occurred (or have ceased) and send a conventional message to wireless network 100 to activate (or deactivate) the Selective Call Acceptance feature.

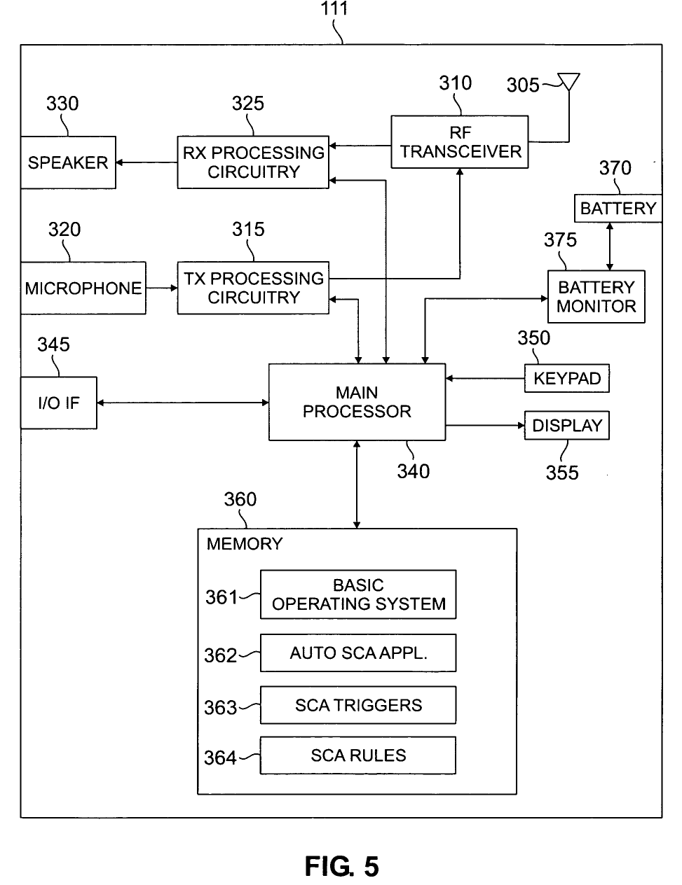

FIG. 5 illustrates wireless mobile station 111 according to an alternate embodiment of the present invention. Mobile station 111 in FIG. 5 is similar in most significant respects to mobile station 111 in FIG. 3. However, memory 360 comprises basic operating system (OS) program 361 and automatic Selective Call Acceptance (SCA) application program 362, as well as SCA triggers list 363 and SCA rules list 364. In this embodiment, automatic SCA application program 362 performs the functions previously performed by SCA controller 230 with respect to SCA triggers list 363 and SCA rules list 364.

As before, the operator (user) of mobile station (MS) 111 initially uses the graphical user interface (GUI) to perform a menu-driven procedure that enables the operator to define SCA trigger events and SCA rules. The operator also uses the GUI of MS 111 to enter the required SCA phone numbers, namely the calling phone numbers that are to be forwarded and the phone number(s) of the voice mail system or other voice to which the calling phone numbers are to be forwarded (or diverted). This is similar to process step 405 above. However, only the SCA phone numbers need to be transferred to wireless network 100.

In the embodiment in FIG. 5, the defined SCA trigger events and SCA rules are stored in SCA triggers list 363 and SCA rules list 364. Thereafter, automatic SCA application program 362 monitors the call session information in mobile station 111 to determine if any of the SCA trigger events and/or SCA rules are matched. Information such as peak hours and roaming status are known to the mobile station as well as the network. Thus, automatic SCA application program 362 substitutes for SCA controller 230.

If a match occurs, automatic SCA application program 362 transmits to wireless network 100 the same keystrokes that an operator would enter manually to activate SCA mode. When a match no longer occurs, automatic SCA application program 362 transmits to wireless network 100 the same keystrokes that an operator would enter manually to de-activate SCA mode. Thus, from the perspective of wireless network 100, it appears that the operator of MS 111 is manually activating and de-activating SCA mode, even though it is automatic SCA application program 362 that causes these actions.

Although the present invention has been described with an exemplary embodiment, various changes and modifications may be suggested to one skilled in the art. It is intended that the present invention encompass such changes and modifications as fall within the scope of the appended claims.

What is claimed is:

1. For use in a wireless network comprising a plurality of base station capable of communicating with a plurality of mobile stations, a system for providing automatic Selective Call Acceptance (SCA) service to the plurality of mobile stations, comprising:
a subscriber records database capable of storing a plurality of subscriber records, each subscriber record associated with one of the mobile stations and comprising SCA data for providing automatic SCA service to the associated mobile station, the SCA data comprising an SCA triggers list, the SCA triggers list comprising user-defined trigger events; and
an SCA controller capable of accessing the subscriber records database and to provide automatic SCA service to at least one of the mobile stations based on the SCA data stored in the subscriber record for the associated mobile station.

2. The system as set forth in claim 1, wherein the trigger events comprise at least one of a low battery condition, a roaming condition, and a peak calling hours condition.

3. The system as set forth in claim 1, wherein the SCA controller is further capable of monitoring call session state information for the mobile stations to determine if an SCA trigger event stored in the subscriber record associated with one of the mobile stations is matched.

4. The system as set forth in claim 3, wherein the SCA controller is further capable of automatically activating SCA service for one of the mobile stations when the SCA controller determines that one of the SCA trigger events stored in the subscriber record associated with the mobile station is matched.

5. The system as set forth in claim 4, wherein the SCA controller further is capable of monitoring the call session state information for the mobile station receiving automatic SCA service to determine if the SCA trigger event is still matched and to determine if one of the remaining SCA trigger events for the mobile station is matched.

6. The system as set forth in claim 5, wherein the SCA controller is further capable of automatically deactivating SCA service when the SCA controller determines that the SCA trigger event is unmatched and the remaining SCA trigger events for the mobile station are unmatched.

7. The system as set forth in claim 1, wherein the SCA data further comprises an SCA phone numbers list.

8. The system as set forth in claim 7, wherein the SCA phone numbers list comprises at least one call diversion number and at least one diverted phone number.

9. The system as set forth in claim 1, wherein the SCA data further comprises an SCA rules list, the SCA rules list comprising at least one user-defined rule that refines the use of the trigger events in the SCA triggers list.

10. For use in a Selective Call Acceptance (SCA) controller in a wireless network comprising a plurality of base station capable of communicating with a plurality of mobile stations, a method of providing automatic SCA service for the mobile stations, the method comprising the steps of:
accessing a subscriber records database, the subscriber records database capable of storing a plurality of subscriber records, each subscriber record associated with one of the mobile stations and comprising SCA data for providing automatic SCA service to the associated mobile station, the SCA data comprising an SCA triggers list, the SCA triggers list comprising user-defined trigger events; and
providing automatic SCA service to at least one of the mobile stations based on the SCA data stored in the subscriber record for the associated mobile station.

11. The method as set forth in claim 10, wherein the trigger events comprise at least one of a low battery condition, a roaming condition, and a peak calling hours condition.

12. The method as set forth in claim 10, further comprising the steps of:
monitoring call session state information for the mobile stations to determine if an SCA trigger event stored in the subscriber record associated with one of the mobile stations is matched; and
automatically activating SCA service for one of the mobile stations when one of the SCA trigger events stored in the subscriber record associated with the mobile station is matched.

13. The method as set forth in claim 12, further comprising the steps of:
monitoring the call session state information for the mobile station receiving automatic SCA service to determine if the SCA trigger event is still matched and to determine if one of the remaining SCA trigger events for the mobile station is matched; and
automatically deactivating SCA service when the SCA trigger event is unmatched and the remaining SCA trigger events for the mobile station are unmatched.

14. The method as set forth in claim 10, wherein the SCA data further comprises an SCA phone numbers list, the SCA phone numbers list comprising at least one call diversion number and at least one diverted phone number.

15. The method as set forth in claim 10, wherein the SCA data further comprises an SCA rules list, the SCA rules list comprising at least one user-defined rule that refines the use of the trigger events in the SCA triggers list.

16. A method for use in a mobile station capable of communicating with a wireless network comprising a plurality of mobile stations, the wireless network capable of providing automatic Selective Call Acceptance (SCA) service to the mobile station, the method comprising the steps of:
receiving user input from a user of the mobile station, the user input comprising at least one user-defined trigger event, at least one call diversion number, and at least one diverted phone number; and
sending the user input to the wireless network for storing in a subscriber record associated with the mobile station, the subscriber record capable of being used to provide automatic SCA service for the mobile station.

17. The method as set forth in claim 16, wherein the trigger event comprises one of a low battery condition, a roaming condition, and a peak calling hours condition.

18. The method as set forth in claim 17, further comprising the step of, when the trigger event comprises the low battery condition, prompting the user to provide a battery power level corresponding to the low battery condition and receiving the battery power level from the user.

19. The method as set forth in claim 17, further comprising the step of, when the trigger event comprises the peak calling hours condition, prompting the user to provide peak calling hours corresponding to the peak calling hours condition and receiving the peak calling hours from the user.

20. The method as set forth in claim 16, further comprising the steps of:
receiving a battery power level for a battery in the mobile station; and
sending one of an SCA activation message and an SCA deactivation message to the wireless network based on the battery power level.
